(19) United States
(12) Patent Application Publication
(10) Pub. No.: US 2005/0283763 A1
(43) Pub. Date: Dec. 22, 2005

(54) Exception test support technique

(75) Inventors: Ryoko Fujikawa, Kawasaki (JP); Tetsuya Katayama, Oita (JP); Kinya Miyazaki, Oita (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/948,308

(22) Filed: Sep. 24, 2004

(30) Foreign Application Priority Data
May 25, 2004 (JP) 2004-154234

(51) Int. Cl. G06F 9/44

(52) U.S. Cl. 717/124

(57) ABSTRACT

This invention is to provide a technique for automatically performing a test of exception handling in a program created by using an object-oriented programming language. The method according to this invention comprises: analyzing a source program to be tested; generating a driver class for invoking a method of classes included in the source program to be tested; storing data of lines in the source program to be tested, which are executed by the driver class, so as to correspond to the driver class; extracting the driver class for causing a line for invoking a specific method having a possibility that an exception occurs to be executed; generating an exception occurrence stub class as a class having a same name as a name of a specific class, wherein the exception occurrence stub class has a method, which generates the exception and has a same name as a name of the specific method; and executing the driver class and the exception occurrence stub class, and storing execution result data.

### TECHNICAL FIELD OF THE INVENTION

The present invention relates to a test technique of exception handling in a program created by using an object-oriented programming language such as Java (trademark of Sun Microsystems, Inc.) or C++.

### BACKGROUND OF THE INVENTION

In program development, the number of steps required in a test process is very large. In the case where the quality is regarded as important, the ratio of the number of steps for a programming process and a test process becomes “programming”: “test”=2:8.

For the purpose of achieving the improvement in efficiency of a test as a significant problem in the program development as stated above, a test support tool is generally used. Current test support tools include a static test for analyzing programming contents and a dynamic test performed by executing an actually compiled program. By performing the respective tests, it is possible to perform tests supposed in software. However, with respect to exception handling which can be occur in a test depending on a hardware problem, such as a memory shortage at the time of program execution or a hard failure, and/or in the case where a problem relating to an OS (Operating System) or other software arises, it is very difficult to produce the exception state. Thus, in the development using the object-oriented programming language, a test for a location where an exception is handled has had to be performed after such an environment that the exception occurs is manually created in hardware, or after a dedicated test environment is separately prepared. That is, in the present circumstances, even if programming is performed with the programming language in which the logic of exception handling can be actually incorporated, it is difficult to completely perform the test.

For example, JP-A-5-257740 discloses a technique as described below. That is, in a case where a test is performed for each individual object of plural objects, the technique includes a translation processing of translating a source program to generate an object and external interface information, a linkage compile processing of generating an object on the basis of the external interface information with respect to an unsolved external call and unsolved external reference in the object and generating a program in an executable form, an execution processing of performing the execution control of the program in the executable form, an output data information storage of storing output information of the program in the executable form, an automatic execution processing of automatically performing execution on the basis of input data information storage storing input information for the program in the executable form, and a means of automatically judging an executed result by investigating the stored output information and output information outputted by the automatic execution processing. This publication does not particularly describe an exception.

As stated above, there is no related art enabling a test of exception handling to be automatically performed without preparing a special environment.

### SUMMARY OF THE INVENTION

An object of the invention is therefore to provide a novel technique for automatically performing a test of exception handling in a program created by using an object-oriented programming language.

An exception test support method according to a first aspect of the invention comprises: if a source program to be tested is analyzed, and a specific method having a possibility that an exception occurs is detected in a specific class of the source program to be tested, storing data of the specific class, the specific method and the exception into a storage device; and referring to the storage device, generating an exception occurrence stub class as a class having the same name as the name of the specific class, wherein the exception occurrence stub has a method, which generates the exception and has the same name as the name of the specific method, and storing it into the storage device. As stated above, because the exception can be made to artificially occur by automatically generating the exception occurrence stub class, the test of the exception handling can be automated.

An exception test support method according to a second aspect of the invention comprises: analyzing a source program to be tested, specifying classes contained in the source program to be tested and methods contained in the classes, storing data of the classes and the methods into an analysis result storage, and if a specific method having a possibility that an exception occurs is detected in a specific class of the source program to be tested, storing line data of invoking the specific method into the analysis result storage; referring to the analysis result storage, generating a driver class (also called as a driver program) for invoking the method of the specified class, and storing it into a driver storage; causing the driver class stored in the driver storage to be executed, storing data of lines in the source program to be tested, which are executed by the driver class, so as to correspond to the driver class into an executed line data storage; and extracting the driver class for causing a line for invoking the specific method to be executed, based on the data stored in the analysis result storage and the data stored in the executed line data storage, and storing data of the extracted driver class into a storage device.

As stated above, by executing the driver class once and collecting data of the executed lines, it can be confirmed that the specific method having the possibility that the exception occurs can be invoked by executing which driver class, and it becomes possible to specify the driver classes necessary for the exception test without omission to the utmost.

In addition, the aforementioned analyzing may comprise: if the specific method having the possibility that the exception occurs is detected in the specific class of the source program to be tested, storing the exception data into the analysis result storage so as to correspond to the specific class and the specific method. At that time, the exception test support method according to the second aspect of the invention may further comprise: referring to the data stored in the analysis result storage, generating an exception occurrence stub class as a class having a same name as a name of the specific class, wherein the exception occurrence stub has a method, which generates the exception and has a same name as a name of the specific method, and storing it into an exception occurrence stub storage; and executing the driver class stored in the driver storage and the exception occurrence stub class stored in the exception occurrence stub storage in accordance with the data of the extracted driver class stored in the storage device, and storing execution result data into an execution result storage. As a result, the exception occurrence stub class for generating the exception is invoked by the specified driver class, and the test when the exception occurred can be executed.

The data of the extracted driver class may include correspondence data between the driver class and the specific method of the specific class. At that time, the executing and storing may comprise: when a specific driver class is executed, referring to the. correspondence data, and dynamically replacing (hot-swapping) the specific method of the specific class corresponding to the specific driver class with a method of the exception occurrence stub class having the same name as the name of the specific class. As a result, the exception occurrence stub class can be executed only when needed.

The exception test support method of the invention can be implemented by a computer and a program executed by the computer, and this program is stored in a storage medium or a storage device such as, for example, a flexible disk, a CD-ROM, a magneto-optical disk, a semiconductor memory, or a hard disk. The program may be delivered as digital signals through a network or the like. Incidentally, intermediate processing results are temporarily stored in a storage device such as a main memory.

### BRIEF DESCRIPTION OF THE DRAWINGS

FIG. 1 is a functional block diagram of an exception test support apparatus according to an embodiment of the invention;

FIG. 2 is a diagram showing a processing flow according to the embodiment of the invention;

FIG. 3 is a diagram showing an example of a source program to be tested;

FIG. 4 is a diagram showing an example of a first source program invoked from the source program to be tested;

FIG. 5 is a diagram showing an example of a second source program invoked from the source program to be tested;

FIG. 6 is a diagram showing an example of a test program;

FIG. 7 is a diagram showing an example of coverage data;

FIG. 8 is a diagram showing an example of a data table for generating an exception occurrence stub class;

FIGS. 9A to 9D are diagrams showing examples of exception occurrence stub classes;

FIG. 10 is a diagram showing a correspondence between a method and a driver program;

FIG. 11 is a diagram showing a display screen example; and

FIG. 12 is a diagram showing a functional diagram of a computer system according to the embodiment of this invention.

### DETAILED DESCRIPTION OF THE PREFERRED EMBODIMENTS

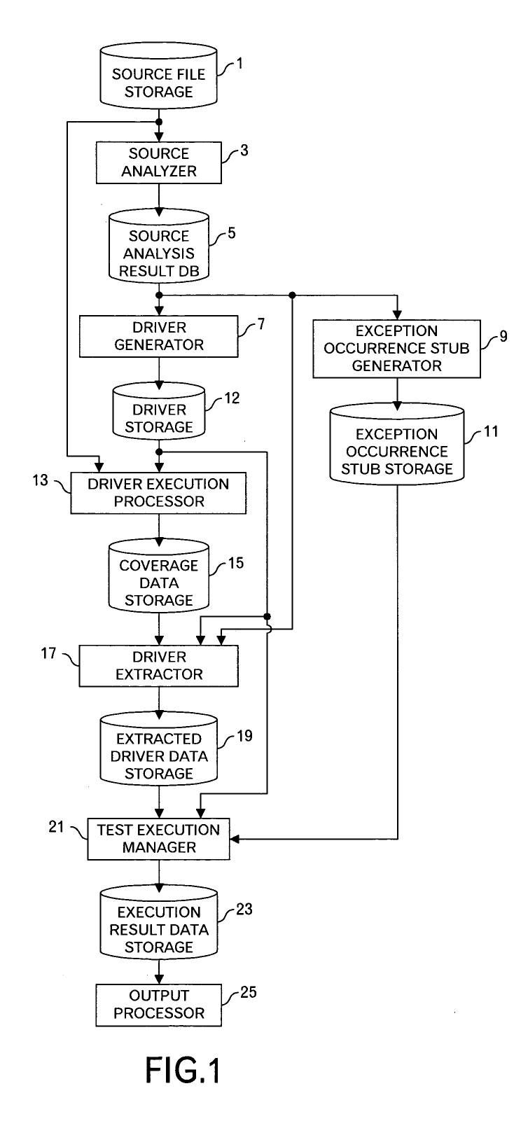

FIG. 1 shows a functional block diagram of an exception test support apparatus according to an embodiment of this invention. The exception test support apparatus includes a source file storage 1, a source analyzer 3, a source analysis result database (DB) 5, a driver generator 7, a driver storage 12, a driver execution processor 13, a coverage data storage 15, a driver extractor 17, an extracted driver data storage 19, a test execution manager 21, an exception occurrence stub generator 9, an exception occurrence stub storage 11, an execution result data storage 23, and an output processor 25.

The source file storage 1 stores a file such as a source program to be tested. The source analyzer 3 performs an analysis processing of the source program to be tested stored in the source file storage 1, and stores an analysis result into the source analysis result DB 5. The driver generator 7 uses the data stored in the source analysis result DB 5 to automatically generate driver classes for invoking all methods in the source program to be tested, and stores data of the generated driver classes into the driver storage 12. The driver execution processor 13 executes the driver classes stored in the driver storage 12 to execute relevant lines of the source program to be tested stored in the source file storage 1, and stores data concerning the execution lines into the coverage data storage 15. The driver extractor 17 refers to the data stored in the source analysis result DB 5 and the data stored in the coverage data storage 15, extracts, in driver classes stored in the driver storage 12, a driver class for invoking a method having a possibility that an exception occurs in the source program to be tested, and stores data of the extracted driver class into the extracted driver data storage 19. The exception occurrence stub generator 9 refers to the data of the source analysis data storage 5, automatically generates an exception occurrence stub class corresponding to the method having the possibility that the exception occurs in the source program to be tested, and stores it, together with associated data, into the exception occurrence stub storage 11. The test execution manager 21 refers to the data stored in the extracted driver data storage 19, executes the driver class extracted by the driver extractor 17 in the driver classes stored in the driver storage 12, executes the method of the exception occurrence stub class stored in the exception occurrence stub storage 11 instead of the method having the possibility that the exception occurs, and stores an execution result into the execution result data storage 23. The output processor 25 presents the data stored in the execution result data storage 23 to the user. In each of the processing elements, there is also a case where reference is made to a storage not shown in FIG. 1.

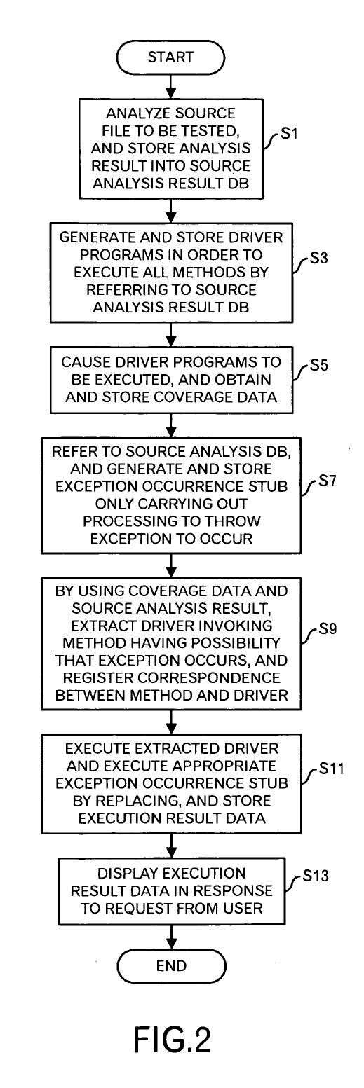

Next, the processing flow of the exception test support apparatus shown in FIG. 1 will be described with reference to FIGS. 2 to 11. FIG. 2 shows the processing flow of the exception test support apparatus. First, the source analyzer 3 reads out a source program to be tested from the source file storage 1 and a program invoked from the source program, performs a specific analysis, and stores an analysis result into the source analysis result DB 5 (step S1). The source analyzer 3 extracts the class information, method information, argument information and exception handling information of the source program to be tested, and the class information, method information, return value information and exception handling information of classes invoked from the source program to be tested, and stores them into the source analysis result DB 5. In more details, with respect to each of the classes to be tested and the classes invoked from the classes to be tested, there are included a class name, a method name contained in the class, and a line number defining the method name, and with respect to each method, there are included a source code effective line number (line number of a line actually executed in the program), a line number of a line invoking a method having a possibility that an exception occurs, a line number of a line in which a processing having a possibility that an exception occurs and a processing of the occurred exception (in the case of Java, try-catch) are described and its contents, contents of a comment line and its defined line number, information (including an argument) of another method invoked in the source program and its defined line number, data of the occurring exception (in the case of Java, an exception name after throws declaration and a method actually throwing the exception) and the like.

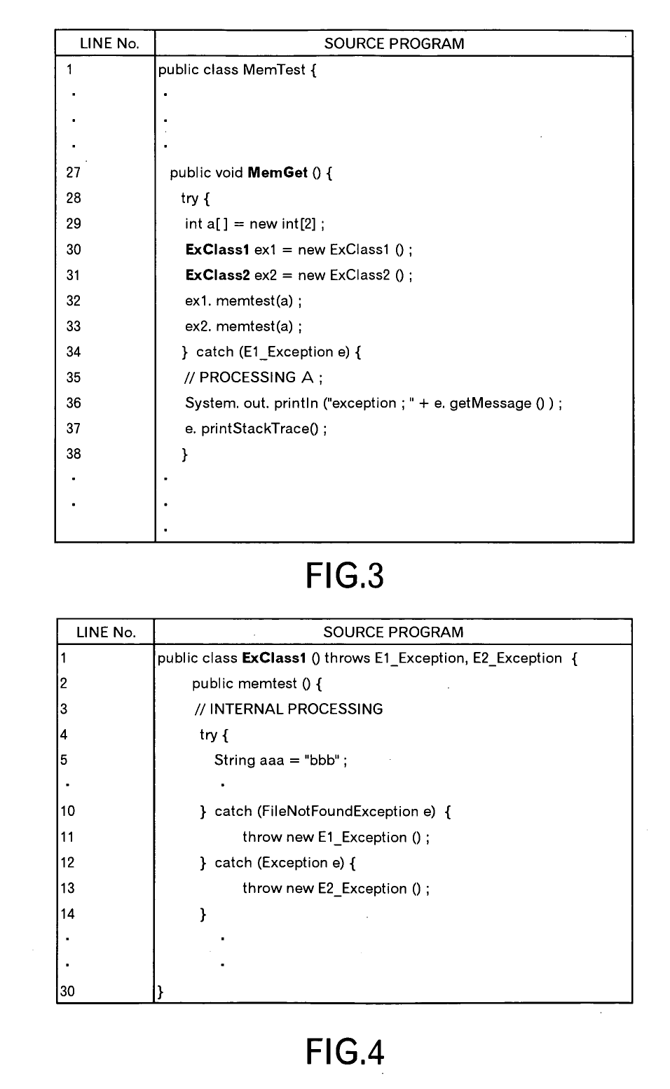

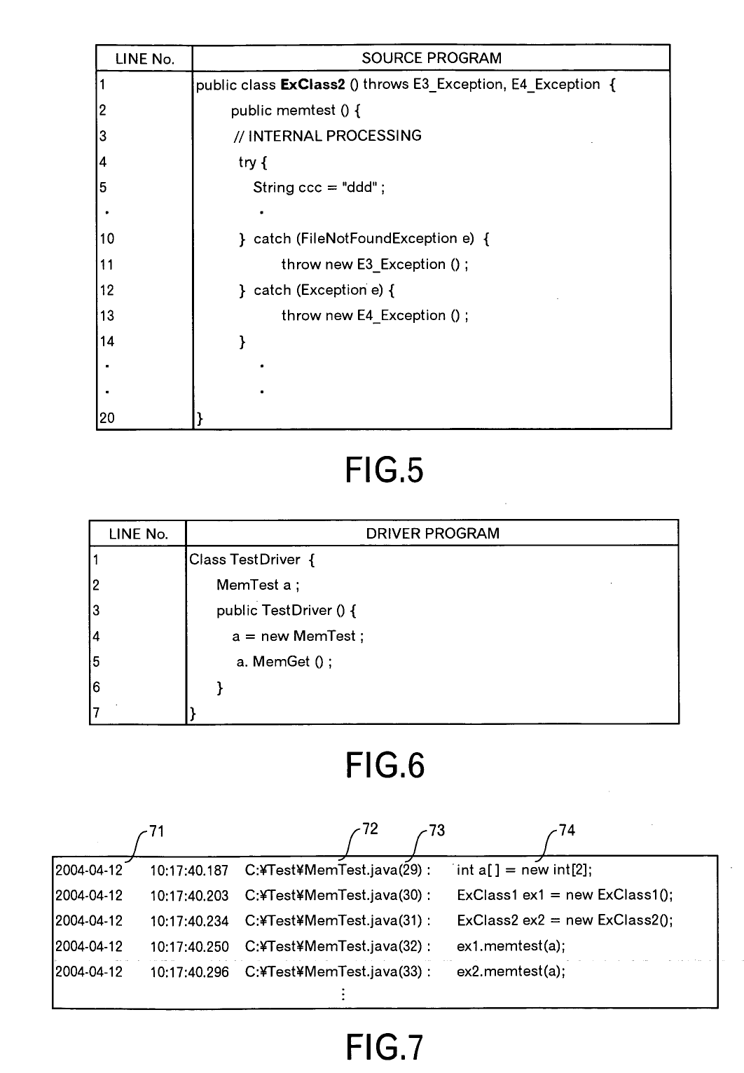

It is assumed that for example, MemGet( ) method of MemTest class as shown in FIG. 3 is the source program to be tested. Besides, it is assumed that classes as shown in FIGS. 4 and 5 are invoked. In the case of this example, with respect to the MemTest class, “MemGET( )” and “27” as a method name contained in the class and a line number defining the method name, “29, 30, 31, 32, 33, 36 and 37” as source code effective line numbers, “32” and “33” as line numbers of lines invoking methods having a possibility that an exception occurs, “28 to 38” and “contents of lines 28 to 38” as line numbers in which a processing having a possibility that an exception occurs and a processing of the occurring exception are described and its contents, “processing A” and “35” as the contents of a comment line and its defined line number, “Exclass1.memtest(a)” and “32” and “Exclass2.memtest(a)” and “33” as other method names invoked in the source program and their defined line numbers, and the like are stored in the source analysis result DB5.

With respect to the ExClass1 class (shown in FIG. 4) invoked by the MemGet( ) method of the MemTest class, “memtest( )” and “2” as a method name contained in the class and a line number defining the method name, “5”, “11” and “13” as source code effective line numbers, “4 to 14” and “contents of lines 4 to 14” as line numbers where a processing having a possibility that an exception occurs and a processing of the occurring exception are described and its contents, “internal processing” and “3” as contents of a comment line and its defined line number, “E1_Exception” and “E2_Exception” as data of the occurring exception, and the like are stored in the source analysis result DB 5.

Further, with respect to the ExClass 2 class (shown in FIG. 5) invoked by the MemGet( ) method of the MemTest class, “memtest0” and “2” as a method name contained in the class and a line number defining the method name, “5”, “11” and “13” as source code effective line numbers, “4 to 14” and “contents of lines 4 to 14” as line numbers where a processing having a possibility that an exception occurs and a processing of the occurring exception are described and its contents, “internal processing” and “3” as contents of a comment line and its defined line number, “E3_Exception” and “E4_Exception” as data of the occurring exception, and the like are stored in the source analysis result DB 5.

Next, the driver generator 7 generates driver programs in order to execute all methods by referring to the source analysis result DB 5, and stores them into the driver storage 12 (step S3). As described above, with respect to the source program to be tested, for each class, names of methods contained in the class are registered in the source analysis result DB 5, and accordingly, the driver program is generated by using the data. In general, various branches are contained in the source program to be tested, and in order to perform the exception test without omission, it is necessary to generate drivers passing through all the branches. Accordingly, in this embodiment, with respect to each of the methods, the driver program for executing the method is generated. Basically, because the driver program has only to invoke a specific method, it includes functions of (1) preparation of the execution (connection processing or the like (in the case of Enterprise Java Beans (EJB), servlet or the like)), (2) invocation of the constructor (invoke the constructor of the class to be tested), (3) invocation of a specific method in the source program to be tested (including: preparing method parameters, preparing method return values, invoking the method and recording method return values), and (4) end processing (disconnection processing or the like). For example, in the case of the driver program for invoking the MemGet( ) method of the MemTest class shown in FIG. 3, the driver program is as shown in FIG. 6. That is, the class to be tested is defined at the first line, the constructor invocation is performed at the fourth line, and the method to be tested is invoked at the fifth line. In the example of FIG. 3, because there is no return value, FIG. 6 does not include a processing therefor.

Next, the driver execution processor 13 causes all the driver programs stored in the driver storage 12 to be executed, acquires executed line information (called as coverage data) in the source program to be tested, through which the execution flow passes when executing each driver program, and stores it in the coverage data storage 15 (step S5). The coverage data is managed for each driver.

For example, in the case of the MemGet( ) method of the MemTest class shown in FIG. 3, when the driver program shown in FIG. 6 is executed, for example, coverage data as shown in FIG. 7 is acquired. In the example of FIG. 7, a column 71 contains executed dates, a column 72 contains file names of an executed source program to be tested (there is also a case where plural file names are contained), a column 73 contains line numbers in the file, and a column 74 contains executed source codes.

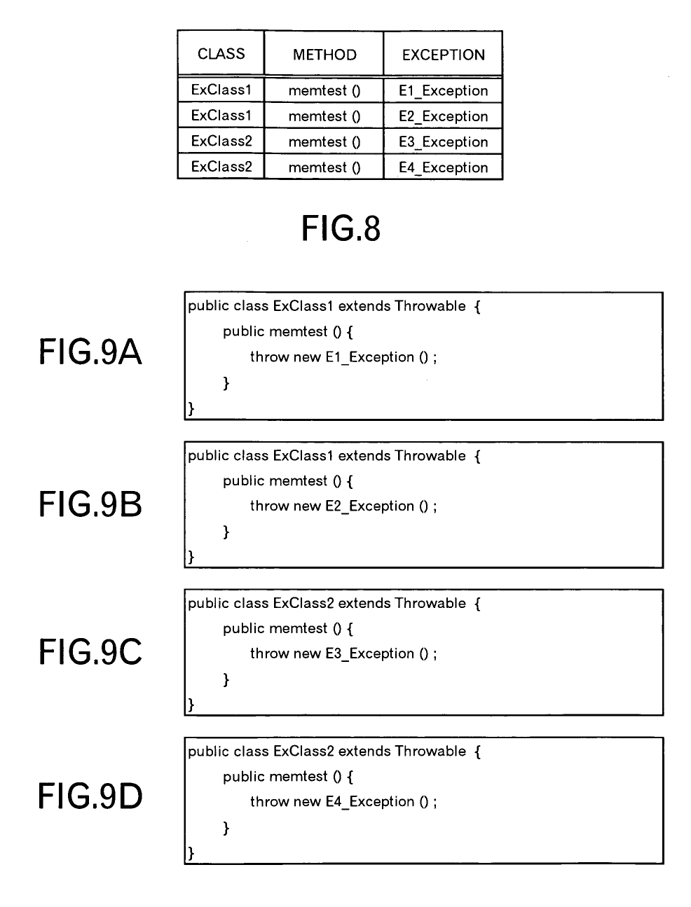

The exception occurrence stub generator 9 refers to the source analysis result DB 5, generates an exception occurrence stub class performing only a processing to throw an exception expected to occur, and stores it in the exception occurrence stub storage 11 (step S7). More specifically, in the source analysis result DB 5, data of the exception to occur (name of exception for which throws declaration is made), the class for which the data is registered and the method in which the exception occurs are specified, a table to generate the exception occurrence stub is prepared, and the source program of the exception occurrence stub class is generated in accordance with the table. Also with respect to the table to generate the exception occurrence stub, in the case of FIGS. 3 to 5, for the memtest( ) methods of the ExClass1 class and ExClass2 class, data of “E1_Exception” and “E2_Exception”, and “E3_Exception” and “E4_Exception” of the exceptions that occur are registered. Accordingly, for example, a table as shown in FIG. 8 is prepared to generate the exception occurrence stub. That is, the table includes a column of classes, a column of methods, and a column of exceptions that occur, and one record is prepared for each of the exceptions that occur. The exception occurrence stub generator 9 generates a source file of an exception occurrence stub class for each record in the table as shown in FIG. 8, builds it, and stores the processing result in the exception occurrence stub storage 11. Although the exception occurrence stub storage 11 and the source file storage 1 may not be physically separate storage devices, at least the directory must be separated. This is because in order to perform a normal operation in a subsequent actual test, the name of the exception occurrence stub class must be made the same name as the class having the possibility that the exception occurs. In the case where plural kinds of exceptions occur for the same method, the name of the exception occurrence stub class must be duplicate, and accordingly, the respective exception occurrence stub classes are stored in the respective directories so that they can be identified by, for example, exception names.

FIGS. 9A to 9D shows examples of source programs of the exception occurrence stub classes generated at the step S7 in the case of FIGS. 3 to 5. FIG. 9A shows the exception occurrence stub class corresponding to the first record of FIG. 8, and the exception occurrence stub class has the same name as the name of the class ExClass 1 having a possibility that an exception occurs. FIG. 9B shows the exception occurrence stub class corresponding to the second record of FIG. 8, and the exception occurrence stub class has the same name as the name of the class ExClass1 having a possibility that an exception occurs. FIG. 9C shows the exception occurrence stub class corresponding to the third record of FIG. 8, and the exception occurrence stub class has the same name as the name of the class ExClass2 having a possibility that an exception occurs. FIG. 9D shows the exception occurrence stub class corresponding to the fourth record of FIG. 8, and the exception occurrence stub class has the same name as the name of the class ExClass2 having a possibility that an exception occurs.

Next, the driver extractor 17 uses the coverage data stored in the coverage data storage 15 and the source analysis result stored in the source analysis result DB 5, extracts a driver program invoking a method having a possibility that an exception occurs, and registers data, such as the correspondence between the method having the possibility that the exception occurs and the driver, into the extracted driver data storage 19 (step S9). By referring to the source analysis result, the line number of the line invoking the method having the possibility that the exception occurs can be specified. On the other hand, the coverage data includes data as to which line was executed for each driver program. Accordingly, the line number of the line invoking the method having the possibility that the exception occurs is specified from the source analysis result, the coverage data including the line number is specified, and the driver program corresponding to the coverage data is extracted. Then, the driver program name and the method having the possibility that the exception occurs are stored in the extracted driver data storage 19.

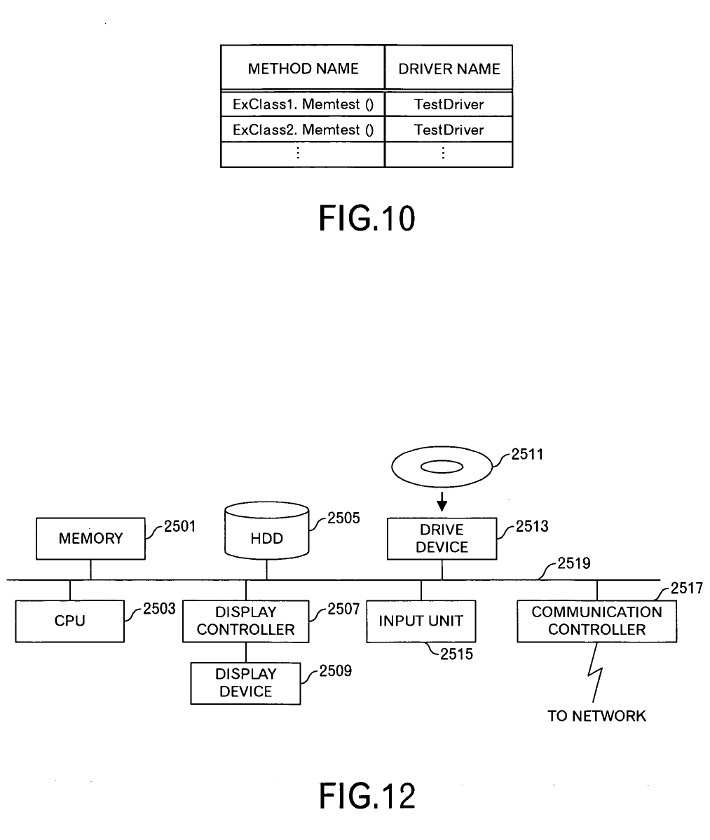

For example, in the case where the source analysis result includes the data indicating that a line invoking a method having a possibility that an exception occurs exists at lines “32” and “33” of FIG. 3, and the coverage data of the driver program (TestDriver) as shown in FIG. 7 is obtained, the coverage data is retrieved with “32” and “33”. Then, because the coverage data of the driver program (TestDriver) contains the line 32 and the line 33, the driver program (TestDriver) is extracted, and is registered so as to correspond to the method names “ExClass1.memtest( )” and “ExClass2.memtest( )”. For example, data as sown in FIG. 10 is stored. In the example of FIG. 10, a column of method names and a column of driver names are provided, and the extracted driver name and the method name having the possibility that the exception occurs are registered.

Incidentally, there is also a case where the line number of a line invoking a method having a possibility that an exception occurs is registered in coverage data of plural driver programs. In such a case, the driver program detected first is extracted. However, a driver program in which a route to the method to be invoked is shortest is optimum, and if possible, such a driver program is extracted. Incidentally, the case where a route is short includes a case where the number of execution lines is small, and a case where an execution time is short. The latter case can be changed according to various conditions such as machine environment at that time and data. However, according to circumstances, in the case where one driver program is selected from plural driver programs, there is also a case where the driver program is selected in which the number of execution lines is small.

Then, the test execution manager 21 refers to the extracted driver data storage 19, the exception occurrence stub storage 11, and the driver storage 12, causes the driver extracted at the step 9 to be executed, causes a suitable exception occurrence stub class to be dynamically replaced (hot-swapped) and to be executed, and stores execution result data into the execution result data storage 23 (step S11). More specifically, the data (FIG. 10) of the correspondence between the method having the possibility that the exception occurs and the driver, which is stored in the extracted driver data storage 19, is used to specify the driver program to be executed. With respect to the method corresponding to the driver program, by referring to the table (FIG. 8) to generate the exception occurrence stub class stored in the exception occurrence stub storage 11, the exception to be generated with respect to the method (class and method) of the same name is specified. Incidentally, in the case where plural kinds of exceptions occur in the same method, as shown in FIGS. 8 and 9, plural exception occurrence stub classes are prepared. Accordingly, even in the same combination of the driver program and the method, there is a case where the combination of the driver program and the exception occurrence stub class is different. Accordingly, the combination of the driver program and the exception occurrence stub class is specified on the basis of the exception to be generated, and the driver program is read out from the driver storage 12 for each combination and is executed. With respect to the method corresponding to the driver program, the exception occurrence stub class concerning the combination is read out from the exception occurrence stub class 11 just before, is dynamically replaced (hot-swapped), and is executed. When debug execution is performed, the execution result can be stored for each step. As a result, only the exception to be checked can be forcibly generated by one execution of a driver program, and it becomes possible to verify the execution result.

In the case of FIG. 10, although two methods (ExClass1.memtest( ) and ExClass2.memtest( )) are registered correspondingly to the driver program TestDriver, when referring to FIG. 8, two exceptions are prescribed with respect to each method. Accordingly, all of the following stories are executed: (1) a story in which the driver TestDriver and the exception occurrence stub Exclass1 for generating the exception E1_Exception are combined, the driver program TestDriver is executed, and the exception occurrence stub ExClass1 for generating the exception E1_Exception is dynamically replaced with (hot-swapped) just before the method ExClass1.memtest( ) is executed, (2) a story in which the driver TestDriver and the exception occurrence stub ExClass1 for generating the reception E2_Exception are combined, the driver program TestDriver is executed, and the exception occurrence stub ExClass1 for generating the exception E2_Exception is dynamically replaced (hot-swapped) just before the method ExClass1.memtest( ) is executed, (3) a story in which the driver TestDriver and the exception occurrence stub ExClass2 for generating the exception E3 Exception are combined, the driver program TestDriver is executed, and the exception occurrence stub ExClass2 for generating the exception E3_Exception is dynamically replaced (hot-swapped) just before the method ExClass2.memtest( ) is executed, and (4) a story in which the driver TestDriver and the exception occurrence stub class ExClass2 for generating the exception E4_Exception are combined, the driver program TestDriver is executed, and the exception occurrence stub ExClass2 for generating the exception E4_Exception is dynamically replaced (hot-swapped) just before the method ExClass2.memtest( ) is executed.

As the execution result, the executed class and method, the exception to be processed (in the case of Java, exception to be caught) the method of the invocation source of the exception, the exception thrown by the method, the output result and the like are stored in the execution result data storage 23.

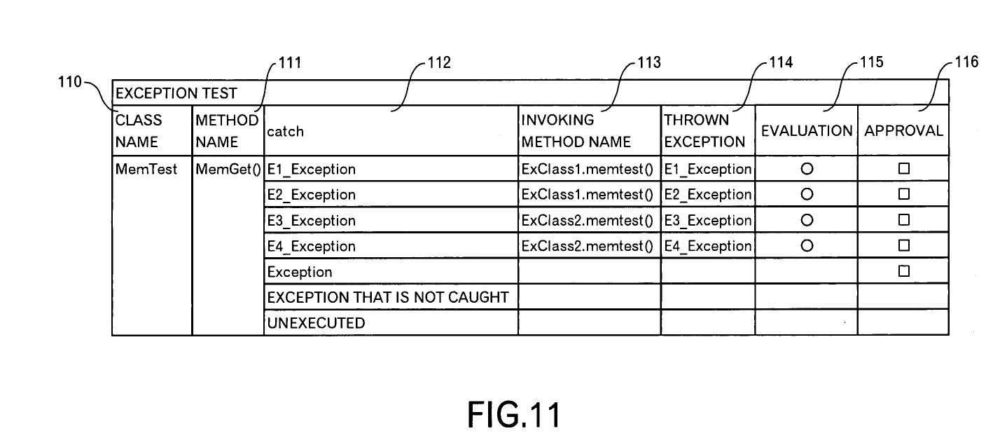

In response to a request from the user, the output processor 25 uses the data stored in the execution result data storage 23 to form a display screen, and displays it on a display device (step S13). For example, a screen as shown in FIG. 11 is displayed. In the example of FIG. 11, there are provided a column 110 of names of classes to be tested, a column 111 of names of methods to be tested, a column 112 of catch to indicate an exception to be processed (in the case of Java, an exception to be caught), a column 113 of invoking method names as method names of an invocation origin, a column 114 of thrown exceptions to indicate occurred exception, a column 115 of evaluations, and a column 116 of approvals. All class names in the source program to be tested are contained in the column 110 of the names of classes. All method names of the classes listed in the column 110 of the names of classes are contained in the column 111 of the names of methods. All exceptions to be processed in the methods specified in the column 110 of the names of classes and the column 111 of names of methods are contained in the column 112 of catch. Incidentally, for this data, there is also a case where reference is made to the source file storage 1 and the source analysis result DB 5. With respect to each of the methods, lines of “exception that is not caught” and “unexecuted” are also added. The “exception that is not caught” is the line for the executed exception, which has not caught. The “unexecuted” is displayed in the case where there is an unexecuted invocation origin method. Besides, for this data, there is also a case where reference is made to the source file storage 1 and the source analysis result DB 5. The column 113 of the invoking method names contains the method names of the methods, in which the exceptions prescribed in the column 112 of catch occur. Incidentally, a method different in the type of argument or the number of arguments is treated as a different method, and there is a case where the same methods are displayed plural times. In the case where there is an unexecuted method, it is indicated in the line of “unexecuted”. The column 114 of the thrown exception indicates the exception thrown by the method indicated in the column 113 of the invocation method names. In the column 115 of the evaluation, in the case where the value of the column 114 of the throw exception is incident with the value of the column 112 of catch, a circle is indicated at the line, in the case where the value of the column 112 of catch is “Exception” and is different from the value of the column 114 of the thrown exception, a triangular is indicated, and in the case where there is an unexecuted method or there is an exception that is not caught, “x” is indicated. The output processor 25 performs the processing to enable the display as shown in FIG. 11.

The user judges from the display contents whether there is no problem, and in the case of approval (there is no problem), a check is placed in the column 116 of the approval. That is, with respect to the input of the check, the output processor 25 receives it, and registers it in, for example, the execution result data storage 23 so that reference can be made thereto later.

By such display, it is possible to perform confirmation as to whether the test has been performed without omission, as to whether there is no problem in programming, and as to whether there is the exception which is caught by only Exception( ). Further, it becomes also possible to find a portion requiring correction when there is something wrong.

As described above, according to this embodiment, the logic of exception handling implemented in the software developed by the user can be tested in the automatically generated environment, and the number of steps required to generated the environment of the software test until now can be greatly reduced. Besides, with respect to a location of the exception handling in which it is difficult to actually generate the software test environment, and a check operation has not been strictly performed even in the test process, it becomes possible to perform the strict test. As a result, a higher reliable program test can be performed, and the quality improvement of the software can be realized.

Although the embodiment of the invention has been described, the invention is not limited to this. For example, the functional block diagram of FIG. 1 is an example, and there is a case where the configuration of the program does not necessarily directly correspond thereto. Besides, in the processing flow of FIG. 2, the step S7 may be performed at any timing after the step S1 to the step S11. Further, it may be executed in parallel to the other steps. The data tables as shown in FIGS. 7, 8 and 10 are examples, and as long as similar contents can be held, the data may be held in any mode. The screen example shown in FIG. 11 is an example, and another screen configuration may be adopted. Besides, more analyses may be performed by the output processor 25.

The exception test support apparatus is a computer, and the computer has a configuration as shown in FIG. 12. That is, a memory 2501, a CPU 2503, a hard disk drive (HDD) 2505, a display controller 2507 connected to a display device 2509, a drive device 2513 for a removal disk 2511, an input device 2515, and a communication controller 2517 for connection with a network are connected through a bus 2519. An operating system (OS) and an application program for carrying out the foregoing processing are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operation. Besides, intermediate processing data is stored in the memory 2501, and if necessary, it is stored in the HDD 2505. In this embodiment of this invention, the application program to realize the aforementioned functions is stored in the removal disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application program are systematically cooperated with each other, so that various functions as described above in details are realized.

Although the present invention has been described with respect to a specific preferred embodiment thereof, various change and modifications may be suggested to one skilled in the art, and it is intended that the present invention encompass such changes and modifications as fall within the scope of the appended claims.

1. An exception test support method, comprising:
if a source program to be tested is analyzed, and a specific method having a possibility that an exception occurs is detected in a specific class of said source program to be tested, storing data of said specific class, said specific method and said exception into a storage device; and
referring to said storage device, and generating an exception occurrence stub class as a class having a same name as a name of said specific class, said the exception occurrence stub having a method, which generates said exception and has a same name as a name of said specific method.

2. An exception test support method, comprising:
analyzing a source program to be tested, specifying classes contained in said source program to be tested and methods contained in said classes, storing data of said classes and said methods into an analysis result storage, and if a specific method having a possibility that an exception occurs is detected in a specific class of said source program to be tested, storing data of a line for invoking said specific method into said analysis result storage;
referring to said analysis result storage, and generating and storing into a driver storage, a driver class for invoking a method of the specified class;
causing said driver classes stored in said driver storage to be executed, and storing data of lines in the source program to be tested, which are executed by said driver class, so as to correspond to said driver class, into an executed line data storage; and
extracting a driver class for causing a line for invoking said specific method to be executed, based on data stored in said analysis result storage and data stored in said executed line data storage.

3. The exception test support method as set forth in claim 2, wherein said analyzing comprises:
if said specific method having said possibility that said exception occurs is detected in said specific class of said source program to be tested, storing exception data into said analysis result storage so as to correspond to said specific class and said specific method, and
said exception test support method further comprises:
referring to data stored in said analysis result storage, generating an exception occurrence stub class as a class having a same name as a name of said specific class, said exception occurrence stub having a method, which generates said exception and has a same name as a name of said specific method, and storing the generated exception occurrence stub class into an exception occurrence stub storage; and
executing said driver class stored in said driver storage and said exception occurrence stub class stored in said exception occurrence stub storage in accordance with data of the extracted driver class, and storing execution result data into an execution result storage.

4. The exception test support method as set forth in claim 3, further comprising:
displaying a screen for confirmation of exception handling, which is generated by using data stored in said execution result storage.

5. The exception test support method as set forth in claim 3, wherein data of the extracted driver class include correspondence data between said driver class and said specific method of said specific class, and
said executing and storing comprises:
when a specific driver class is executed, referring to said correspondence data, and dynamically replacing said specific method of said specific class corresponding to said specific driver class with a method of said exception occurrence stub class having the same name as the name of said specific class.

6. The exception test support method as set forth in claim 2, wherein said extracting comprises:
if a plurality of driver classes, which cause a line invoking said specific method to be executed, are detected, specifying a driver class, which can cause said line invoking said specific method to be executed in the shortest time or route.

7. The exception test support method as set forth in claim 5, wherein said generating said exception occurrence stub class comprises:
if there is a possibility that a plurality of kinds of exceptions occur in said specific method, generating second correspondence data between said specific method and an exception, and
said executing and storing comprises:
referring to said second correspondence data, and specifying an exception occurrence stub class, which generates an exception to be generated at this time for the dynamic replacement.

8. An exception test support program embodied on a medium, said exception test support program comprising:
if a source program to be tested is analyzed, and a specific method having a possibility that an exception occurs is detected in a specific class of said source program to be tested, storing data of said specific class, said specific method and said exception into a storage device; and
referring to said storage device, and generating an exception occurrence stub class as a class having a same name as a name of said specific class, said the exception occurrence stub having a method, which generates said exception and has a same name as a name of said specific method.

9. An exception test support program embodied on a medium, said exception test support program comprising:
analyzing a source program to be tested, specifying classes contained in said source program to be tested and methods contained in said classes, storing data of said classes and said methods into an analysis result storage, and if a specific method having a possibility that an exception occurs is detected in a specific class of said source program to be tested, storing data of a line for invoking said specific method into said analysis result storage;
referring to said analysis result storage, and generating and storing into a driver storage, a driver class for invoking a method of the specified class;
causing said driver classes stored in said driver storage to be executed, and storing data of lines in the source program to be tested, which are executed by said driver class, so as to correspond to said driver class, into an executed line data storage; and
extracting a driver class for causing a line for invoking said specific method to be executed, based on data stored in said analysis result storage and data stored in said executed line data storage.

10. The exception test support program as set forth in claim 9, wherein said analyzing comprises:
if said specific method having said possibility that said exception occurs is detected in said specific class of said source program to be tested, storing exception data into said analysis result storage so as to correspond to said specific class and said specific method, and
said exception test support program further comprises:
referring to data stored in said analysis result storage, generating an exception occurrence stub class as a class having a same name as a name of said specific class, said exception occurrence stub having a method, which generates said exception and has a same name as a name of said specific method, and storing the generated exception occurrence stub class into an exception occurrence stub storage; and
executing said driver class stored in said driver storage and said exception occurrence stub class stored in said exception occurrence stub storage in accordance with data of the extracted driver class, and storing execution result data into an execution result storage.

11. The exception test support program as set forth in claim 10, further comprising:
displaying a screen for confirmation of exception handling, which is generated by using data stored in said execution result storage.

12. The exception test support program as set forth in claim 10, wherein data of the extracted driver class include correspondence data between said driver class and said specific method of said specific class, and
said executing and storing comprises:
when a specific driver class is executed, referring to said correspondence data, and dynamically replacing said specific method of said specific class corresponding to said specific driver class with a method of said exception occurrence stub class having the same name as the name of said specific class.

13. The exception test support program as set forth in claim 9, wherein said extracting comprises:
if a plurality of driver classes, which cause a line invoking said specific method to be executed, are detected, specifying a driver class, which can cause said line invoking said specific method to be executed in the shortest time or route.

14. The exception test support program as set forth in claim 12, wherein said generating said exception occurrence stub class comprises:
if there is a possibility that a plurality of kinds of exceptions occur in said specific method, generating second correspondence data between said specific method and an exception, and
said executing and storing comprises:
referring to said second correspondence data, and specifying an exception occurrence stub class, which generates an exception to be generated at this time for the dynamic replacement.

15. An exception test support apparatus, comprising:
a unit that stores, if a source program to be tested is analyzed, and a specific method having a possibility that an exception occurs is detected in a specific class of said source program to be tested, data of said specific class, said specific method and said exception into a storage device; and
a unit that refers to said storage device, and generates an exception occurrence stub class as a class having a same name as a name of said specific class, said the exception occurrence stub having a method, which generates said exception and has a same name as a name of said specific method.

16. An exception test support apparatus, comprising:
an analyzing unit that analyzes a source program to be tested, specifies classes contained in said source program to be tested and methods contained in said classes, stores data of said classes and said methods into an analysis result storage, and if a specific method having a possibility that an exception occurs is detected in a specific class of said source program to be tested, stores data of a line for invoking said specific method into said analysis result storage;
a unit that refers to said analysis result storage, and generates and stores into a driver storage, a driver class for invoking a method of the specified class;
a unit that causes said driver classes stored in said driver storage to be executed, and stores data of lines in the source program to be tested, which are executed by said driver class, so as to correspond to said driver class, into an executed line data storage; and
an extracting unit that extracts a driver class for causing a line for invoking said specific method to be executed, based on data stored in said analysis result storage and data stored in said executed line data storage.

17. The exception test support apparatus as set forth in claim 16, wherein said analyzing unit comprises:
a unit that stores, if said specific method having said possibility that said exception occurs is detected in said specific class of said source program to be tested, exception data into said analysis result storage so as to correspond to said specific class and said specific method, and
said exception test support apparatus further comprises:
an exception occurrence stub class generating unit that refers to data stored in said analysis result storage, generates an exception occurrence stub class as a class having a same name as a name of said specific class, said exception occurrence stub having a method, which generates said exception and has a same name as a name of said specific method, and stores the generated exception occurrence stub class into an exception occurrence stub storage; and
a driver execution unit that executes said driver class stored in said driver storage and said exception occurrence stub class stored in said exception occurrence stub storage in accordance with data of the extracted driver class, and stores execution result data into an execution result storage.

18. The exception test support apparatus as set forth in claim 17, further comprising:
a unit that displays a screen for confirmation of exception handling, which is generated by using data stored in said execution result storage.

19. The exception test support apparatus as set forth in claim 17, wherein data of the extracted driver class include correspondence data between said driver class and said specific method of said specific class, and
said driver execution unit comprises:
a unit that refers to said correspondence data when a specific driver class is executed, and dynamically replaces said specific method of said specific class corresponding to said specific driver class with a method of said exception occurrence stub class having the same name as the name of said specific class.

20. The exception test support apparatus as set forth in claim 16, wherein said extracting unit comprises:
a unit that specifies a driver class, which can cause said line invoking said specific method to be executed in the shortest time or route, if a plurality of driver classes, which cause a line invoking said specific method to be executed, are detected.

21. The exception test support apparatus as set forth in claim 19, wherein said exception occurrence stub class generating unit comprises:
a unit that generates second correspondence data between said specific method and an exception, if there is a possibility that a plurality of kinds of exceptions occur in said specific method, and
said driver execution unit comprises:
a unit that refers to said second correspondence data, and specifies an exception occurrence stub class, which generates an exception to be generated at this time for the dynamic replacement.
